(19) United States
(12) Patent Application Publication
(10) Pub. No.: US 2026/0103224 A1
(43) Pub. Date: Apr. 16, 2026

(54) SPEED CONTROL

(71) Applicant: Siemens Mobility GmbH, München (DE)

(72) Inventors: Bernhard Faas, Oberreichenbach (DE); Andreas Winzen, Nürnberg (DE); Christian Breuckmann, Erlangen (DE)

(21) Appl. No.: 19/114,539

(22) PCT Filed: Sep. 7, 2023
(86) PCT No.: PCT/EP2023/074587

§ 371 Date: Mar. 24, 2025

(30) Foreign Application Priority Data
Sep. 22, 2022 (DE) 10 2022 209 996.6

(51) Int. Cl. B61L 27/04; G07C 5/02

(52) U.S. Cl. CPC B61L 27/04; G07C 5/02

(57) ABSTRACT

A method for controlling a vehicle includes determining a respective limit speed of a first type and/or a limit speed of a second type by multiple subsystems of the vehicle. A smallest limit speed is selected as a control parameter from a set of determined limit speeds of the first type and limit speeds of the second type. A speed of the vehicle is then controlled based on the control parameter selected in this way. A vehicle control system, a computer program and a computer-readable medium are also provided.

### Description

The invention relates to a method for controlling a vehicle, a vehicle control system, a computer program, and a computer-readable medium.

A vehicle's maximum design speed results from its construction and the maximum performance capability of its weakest subsystem. Such a subsystem can be, for example, a drive system, a vehicle braking system, or a bogie or chassis. In addition to the maximum design speed of a vehicle, the maximum permissible speed of the vehicle may be reduced due to circumstances relating to the current operational state of a subsystem. For example, if elevated temperatures occur during the operation of bearings, of the drive system, or of components of a vehicle's braking system, the relevant subsystem may limit the maximum design speed to a maximum permissible speed of the vehicle. Further reasons for reducing a vehicle's maximum design speed could include for example vibrations affecting vehicle components, a reduction in the vehicle's running stability or insufficient pressure in its pneumatic or hydraulic systems. Thus, different restrictions may exist simultaneously for different subsystems, necessitating a reduction in the maximum design speed. To ensure compliance with the maximum permissible speed as limited by the running of the vehicle, the vehicle's speed is reduced using its braking system if the maximum permissible speed is exceeded. However, this results in significant wear on the subsystems, particularly on the braking system itself.

The object of the invention is to provide a wear-minimizing and operationally safe means of controlling the speed of a vehicle.

This object is achieved by a method for controlling a vehicle in accordance with the features of claim 1. This object is also achieved by a vehicle control system according to the features of the independent device claim, as well as by a computer program according to the features of claim 14 and by a computer-readable medium according to the features of independent claim 15.

Advantageous further developments are set forth in respective dependent claims

In the inventive method for controlling a vehicle, a limit speed of a first type and/or a limit speed of a second type is determined by each of a plurality of subsystems of the vehicle. From a set of the limit speeds of the first type and limit speeds of the second type thus determined, a lowest limit speed is selected as a control parameter. The vehicle speed is then controlled based on the control parameter selected in this way.

Each of the vehicle subsystems mentioned is a functional subunit of the vehicle. These are preferably used to implement the essential vehicle functions. In particular, a sub-system could relate to energy supply, energy conversion, a drive system, a vehicle braking system, a bogie, climate control or access areas such as doors, lifting platforms or loading ramps. The functional subsystems may consist of components and/or assemblies that are spatially distributed in the train. Each subsystem preferably determines a limit speed of the first type and/or limit speed of the second type based on measured values, such as temperature, pressure, running stability or vibrations.

This enables the control parameter to be established centrally based on diverse limit speeds. In addition, it provides a readily comprehensible and transparent method for determining the control parameter. Errors when determining the control parameter can thus be easily avoided as a result. Furthermore, this method can be used to provide vehicle speed control that is tailored to the needs of the sub-systems.

An advantageous further development provides that the limit speed of the second type is determined by a subsystem of the vehicle to prevent damage to the subsystem itself. If a subsystem detects that it might be damaged due to elevated temperatures or vibration events, for example, it can easily and reliably specify a maximum permissible speed. This provides a safe and reliable means of preventing damage to the subsystem. It also helps to reduce the incidence of repairs and associated vehicle downtime.

In addition, an advantageous further development provides that the limit speed of the first type is determined by a subsystem of the vehicle in order to reduce wear. This allows the vehicle speed to be preemptively adjusted before it reaches a level that compromises the safety of the vehicle or a subsystem of the vehicle. Thus, for example, if the temperature of the drive system or vehicle braking system rises, the speed can be reduced early without requiring the vehicle's braking system to intervene. This also helps reduce maintenance and repairs. This makes it possible to further minimize vehicle downtime.

An advantageous further development additionally provides that, for the purpose of selecting the control parameter, the limit speeds of the first type and limit speeds of the second type determined by the plurality of subsystems are transmitted to a central control device. Said control device is designed to store, read, write, transmit and/or manage data in this context. This control device could be, for example, a computer, a microcontroller or similar programmable hardware component. The central management of the limit speeds by means of a control device allows straight-forward and resource-efficient implementation of the control method, while also providing simplified maintenance and servicing thereof.

According to a further advantageous development, a central control device is used to control the vehicle's speed based on the selected control parameter. In particular, said central control device is to be understood as being the control device referred to above. This enables a robust control method to be provided. In contrast to decentralized control of vehicle speed, a uniquely predefined control parameter can be used for speed control purposes. This approach provides a straightforward and resource-efficient means of eliminating control errors resulting from multiple predefined control parameters, as may be the case in particular with decentralized control.

Another advantageous further development provides that, if a limit speed of the second type, as set by a subsystem of the vehicle, is exceeded by a predefined margin, the sub-system requests braking via the vehicle's braking system. For example, in the event that central implementation of speed control based on the aforementioned control parameter is insufficient, the vehicle can still be prevented from exceeding a maximum permissible speed specified by a sub-system. This further enhances the reliability and fail-safety of the control process.

Another advantageous further development is proposed whereby a first threshold value is determined based on the control parameter. If the vehicle's actual speed exceeds the first threshold value, an audible signal is emitted. Alternatively or in addition, a visual signal is emitted if the actual speed of the vehicle exceeds the first threshold value. Said threshold value can be an absolute value or a value dependent on the value of the control parameter. Preferably, a predefined value is added to the control parameter value to determine the threshold value. The audible and/or visual signal, by way of example, can provide a simple means of alerting the driver that the maximum permissible speed has been exceeded. The driver can then adjust their driving behavior as specified by the control parameter and control the vehicle speed accordingly. Excessive stress on the vehicle, such as that caused in particular by emergency braking, can thus be prevented with minimal resource expenditure. Moreover, this approach promotes a proactive and efficient driving style.

In addition, an advantageous further development provides that a second threshold value is determined based on the control parameter. In particular, said threshold value is a threshold value of the type described above. The second threshold value is preferably greater than the first threshold value. If the actual vehicle speed exceeds the second threshold value, a drive lockout is implemented. In this context, drive lockout is to be understood as meaning that a traction setpoint, relating to the vehicle's drive system, is set to zero. This prevents the vehicle from accelerating to a speed greater than the second threshold value, due to the drive thereof. It is additionally made possible to reduce the vehicle's speed with minimal wear and tear.

It is additionally proposed, as an advantageous further development, that a limit value be determined based on the control parameter. Said limit value can be an absolute value or a relative value dependent on the value of the control parameter, which is added to the value of the control parameter. Preferably, the limit value is greater than the first threshold value. With particular preference, the limit value is greater than the second threshold value. This ensures that an excessive speed that could compromise the safety of the vehicle is reliably prevented. Moreover, it enables the vehicle to be protected from damage or, in the case of a rail vehicle, from possible derailment. For example, if the drive lockout has no effect due to a down-hill gradient, vehicle safety can still be ensured.

An advantageous variant provides that the limit value is determined based on a control parameter selected as the limit speed of the second type. Braking of the vehicle by means of the vehicle's braking system can thus be confined to cases where damage to the vehicle is likely. Furthermore, this provides an efficient means of controlling the vehicle's speed.

An advantageous further development also provides that, in addition to a control parameter constituted by a lowest limit speed of the first type, a lowest limit speed of the second type is also taken into account for controlling the vehicle's speed. In this way, the operational safety of the control system can be improved. For example, if speed control occurs, as in this case, based on a limit speed of the first type selected as the control parameter of the second type, no braking by means of the vehicle's braking system will be initially provided. This means that it is possible that the speed of the vehicle will continue to increase despite a drive lockout being provided, for example. In rare cases, this may cause the actual speed of the vehicle to exceed a safety-critical level without any braking being initiated. Here, by taking the limit speed of the second type into account for controlling the vehicle speed, braking can still be provided in the event of a safety-critical speed being exceeded. In addition, the limit speed of the second type taken into account in this way can be used by a train driver or an automated driving and braking control system as an additional preset for operating the vehicle.

The inventive method can be carried out using the vehicle control system according to the invention.

The inventive vehicle control system comprises a control device designed to carry out the method according to the invention. The control device is in particular the control device already described in connection with the inventive method. Using the vehicle control system, the method for controlling speed can be realized in a resource-efficient and reliable manner.

The invention also proposes a vehicle that includes the inventive vehicle control system. In addition, it is proposed that this vehicle comprises a plurality of subsystems. In particular, this vehicle is a rail vehicle incorporating the inventive vehicle control system. In this way, wear and tear on the vehicle's subsystems can be reduced in a resource-efficient manner. The operational safety of the vehicle can also be increased in this way.

In addition, a computer program is inventively provided, comprising instructions that, when the computer program is executed by the control device, cause the vehicle control system according to the invention to carry out the inventive method. The control device referred to is in particular the control device already described above.

The invention also provides a computer-readable medium. This contains instructions which, when executed by a control device, cause the inventive vehicle control system to carry out the method according to the invention. Said control device is in particular the control device already described. The computer-readable medium can be, for example, a CD-ROM, DVD, USB or flash memory, or a non-physical medium, such as a data stream and/or a carrier signal.

The characteristics, features, and advantages of the invention described above, as well as the manner in which they are achieved, will be explained in more detail in the following description of the embodiments of the invention in conjunction with the figures. In the figures, the same reference characters are used as appropriate for the same or corresponding elements of the invention. The exemplary embodiment and the variations described serve to explain the invention and do not limit it to the combinations of features recited therein, including with regard to functional features. Furthermore, all the features recited in the exemplary embodiment can be considered in isolation and can be suitably combined with the features of any claim.

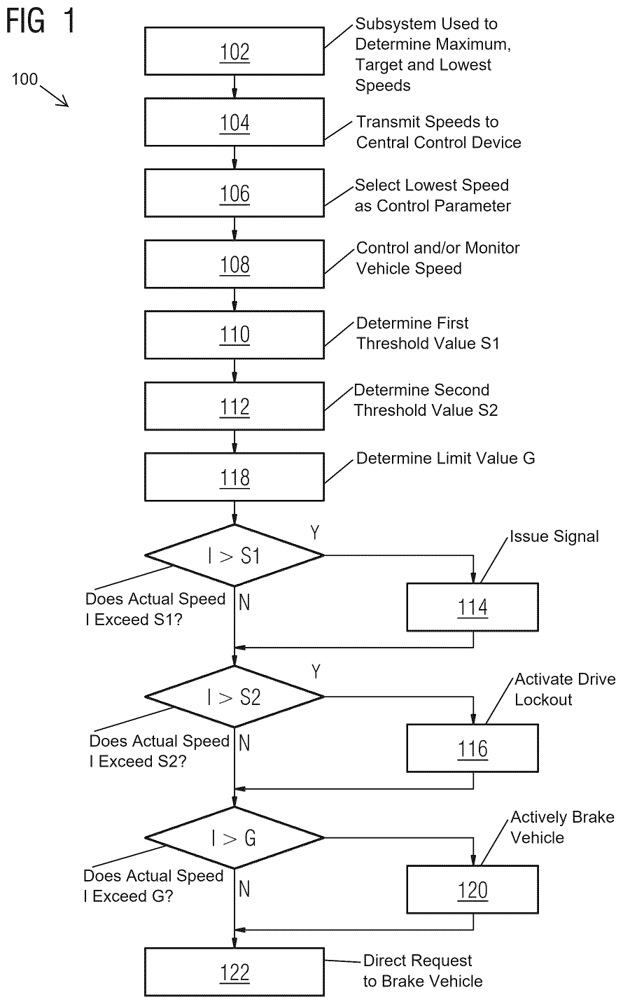

FIG. 1 schematically illustrates an example of a method for controlling the speed of a vehicle;

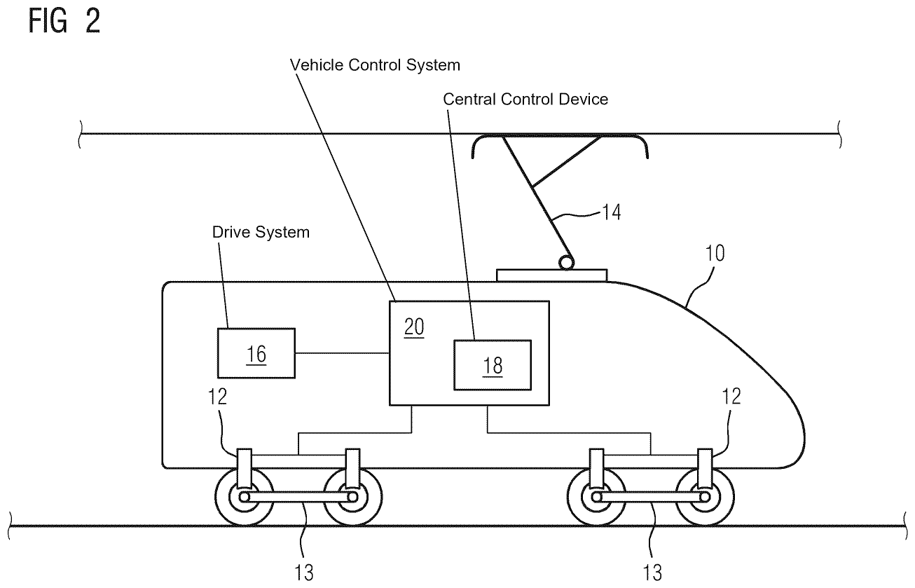

FIG. 2 shows an exemplary embodiment of a vehicle equipped with a vehicle control system by means of which the example of the method illustrated in FIG. 1 can be carried out.

FIG. 1 shows a schematic representation of an example of a method 100 for controlling the speed of a vehicle 10. The vehicle and its associated subsystems 12, 13, 14, 16 are schematically illustrated by way of example in FIG. 2. The vehicle comprises various subsystems 12, 13, 14, 16, each subsystem 12, 13, 14, 16 relating to a functional subunit of the vehicle 10. The method 100 is illustrated using the example of a vehicle braking system 12, a bogie 13, a pantograph 14 and a drive system 16 as subsystems 12, 13, 14, 16 of the vehicle 10. In FIG. 2, these subsystems are shown, by way of example, in a first car of a rail vehicle of a train assembly (not shown in further detail). This car is representative of other cars making up the train assembly, and their respective subsystems.

During operation of the vehicle 10, each of the aforementioned subsystems 12, 13, 14, 16 determines an associated target speed and/or an associated maximum speed 102 as applicable. The maximum speed is determined 102 by the respective subsystem 12, 13, 14, 16 for the purpose of preventing damage to that subsystem 12, 13, 14, 16. For example, if the temperature of the vehicle braking system 12, the bogie 13 or the drive system 16 reaches a critical value, the corresponding subsystem 12, 13, 16 will specify a maximum speed to prevent further temperature increases and any resulting damage or hazard. It is also conceivable that the bogie 13 will start to vibrate, thus impairing running stability. To prevent possible derailment of the vehicle as a result of this, a maximum speed will then be specified by said subsystem 13.

In contrast to the maximum speed, the target speed is determined by a respective subsystem 12, 13, 14, 16 for the purpose of reducing wear 102. For example, if a subsystem 12, 13, 16 registers a temperature increase which, if driving behavior remains unchanged, is likely to result in a critical temperature being reached in the vehicle braking system 12, parts of the bogie 13 or the drive 16, a target speed can be specified by the respective subsystem 12, 13, 16 before this critical temperature value is reached in order to prevent any further rise in temperature. It is also conceivable that a vibration frequency of the pantograph 14 may foreseeably approach a natural frequency. To prevent resonance, a target speed can be specified even before a critical vibration frequency is reached, thereby preventing the pantograph 14 from being vibrated in the first place. The target speed thus enables a driving mode which ensures that wear on the subsystems 12, 13, 14, 16 remains within tolerance. In particular, it also enables wear on the vehicle braking system 12 to be kept within tolerance.

From a set of target speeds and/or maximum speeds determined 102, for example, by each subsystem 12, 13, 14, 16 in the aforementioned manner, a lowest speed is selected 106 as the control parameter. It is conceivable for some of the subsystems 12, 13, 14, 16, depending on their operating state, to determine 102 both a target speed and a maximum speed or only one of these speeds or no speed at all that differs from the maximum design speed of the respective subsystem 12, 13, 14, 16.

For the purpose of selecting 106 a lowest speed as the control parameter, in the present example of the method 100 the subsystems 12, 13, 14, 16 of the vehicle transmit 104 the speeds determined 102 to a central control device 18 of the vehicle 10. In this example of the method 100, the speed of the vehicle is also controlled 108 and/or monitored by means of the control device 18 based on the control parameter selected 106 in the aforementioned manner.

In addition, the example of the method 100 described in connection with FIG. 1 provides that a first threshold value S1 and a second threshold value S2 are determined 110, 112 based on the control parameter. By way of example, the first threshold value S1 is determined by adding 110 a pre-determined value to the value of the control parameter. The second threshold value S2 is determined in the same way 112, but such that it is greater than the first threshold value S1. Furthermore, a limit value G is determined 118 based on the control parameter. In the present example of the method 100, a distinction is made as to whether the control parameter was selected 106 based on a target speed or a maximum speed. In the event that a smallest maximum speed specified by the subsystems 12, 13, 14, 16 was selected 106 as the control parameter, the limit value G is determined 118 solely based on the control parameter. Said limit value G is determined 118 by adding a predefined value to the value of the control parameter. In this example of the method 100, the limit value G determined in this way is greater than the first threshold value S1 and greater than the second threshold value S2. If, on the other hand, a lowest target speed specified by the subsystems 12, 13, 14, 16 has been selected 106 as the control parameter, the determination 118 of the limit value G is based on a lowest maximum speed specified by the subsystems 12, 13, 14, 16. In this case, the limit value G in this example of the method 100 is determined 118 by adding the predefined value and the value of the smallest maximum speed specified by the subsystems 12, 13, 14, 16. In this example of the method 100, the limit value G determined in this way is greater than the first threshold value S1 and greater than the second threshold value S2.

Based on the aforementioned threshold values S1, S2 and the limit value G, the vehicle speed is controlled 108, as set out below by way of example, using the control device 18 in accordance with the method 100 described in connection with FIG. 1.

If the actual speed I of the vehicle exceeds the first threshold value S1, an audible and/or visual signal is issued 114 to the vehicle driver (not shown in detail). By way of example, these signals inform the vehicle driver about the value of the control parameter or type of speed to be targeted. It is also conceivable for the driver to be issued 114 with instructions for the purpose of controlling 108 the vehicle speed. The driver can then take appropriate action to reduce 108 the vehicle speed. If the action taken by the driver is ineffective or if the driver fails to act, and the actual speed I of the vehicle exceeds the second threshold value S2, a drive lockout is activated 116. This drive lockout sets the traction setpoint of the drive 16 to zero. In this way, for example, the vehicle driver is prevented from using the drive system 16 to accelerate the vehicle beyond the value of the control parameter.

If an actual speed I of the vehicle is above the limit value G, the vehicle is actively braked 120 using its braking system 12. In the event that the actual speed I exceeds the limit value G, the example of the method 100 described in connection with FIG. 1 also provides, for the purpose of controlling 108 the vehicle speed, that in addition to the control device 18, a direct request 122 to brake the vehicle by means of the vehicle braking system 12 is made to the vehicle braking system 12 by the subsystem 12, 13, 14, 16 that has specified the smallest maximum speed. This provides a particularly safe method 100 for controlling the vehicle speed, since a maximum permissible speed specified by a subsystem 12, 13, 14, 16 is monitored by two instances.

FIG. 2 schematically illustrates an exemplary embodiment of the vehicle 10. The vehicle is, for example, a rail vehicle and comprises a plurality of subsystems 12, 13, 14, 16. The schematically illustrated subsystems 12, 13, 14, 16 of the vehicle are, by way of example, the subsystems already mentioned in connection with FIG. 1, namely a vehicle braking system 12, a bogie 13, a pantograph 14 and a drive system 16. The vehicle also has a vehicle control system 20. Said vehicle control system 20 in turn has a control device 18 which is designed to carry out the method 100 described in connection with FIG. 1.

Although the invention has been illustrated and described in detail by the preferred embodiments, it is not limited by the disclosed examples and other variations will be apparent to persons skilled in the art without departing from the scope of protection of the invention.

1-15. (canceled)

16. A method for controlling a vehicle, the method comprising:
using each of a plurality of subsystems of the vehicle to determine at least one of a limit speed of a first type or a limit speed of a second type;
selecting a smallest limit speed as a control parameter from a set of the determined limit speeds of the first type and limit speeds of the second type; and
controlling a speed of the vehicle based on the selected control parameter.

17. The method according to claim 16, which further comprises determining the limit speed of the second type by a subsystem of the vehicle for preventing damage to the subsystem.

18. The method according to claim 16, which further comprises determining the limit speed of the first type by a subsystem of the vehicle for reducing wear.

19. The method according to claim 16, which further comprises transmitting the limit speeds of the first type and limit speeds of the second type determined by the plurality of subsystems to a central control device for selecting the control parameter.

20. The method according to claim 16, which further comprises using a central control device to control the speed of the vehicle based on the selected control parameter.

21. The method according to claim 16, which further comprises, upon exceeding a predetermined limit speed of the second type specified by a subsystem of the vehicle, using the subsystem to request braking of the vehicle by utilizing a braking system of the vehicle.

22. The method according to claim 16, which further comprises:
determining a first threshold value based on the control parameter; and
outputting at least one of an audible or visual signal upon an actual speed of the vehicle exceeding the first threshold value.

23. The method according to claim 22, which further comprises:
determining a second threshold value based on the control parameter; and
providing a drive lockout upon the actual speed of the vehicle exceeding the second threshold value.

24. The method according to claim 16, which further comprises:
determining a limit value based on the control parameter; and
braking the vehicle by using a braking system of the vehicle upon an actual speed of the vehicle exceeding the limit value.

25. The method according to claim 24, which further comprises:
determining the limit speed of the second type by a subsystem of the vehicle for preventing damage to the subsystem; and
determining the limit value based on a control parameter selected as the limit speed of the second type.

26. The method according to claim 16, which further comprises taking a control parameter constituted by a smallest limit speed of the first type, as well as a smallest limit speed of the second type, into account for speed control of the vehicle.

27. A vehicle control system, comprising a control device configured to carry out the method according to claim 16.

28. A vehicle, comprising:
a plurality of subsystems; and
a vehicle control system including a control device, said vehicle control system configured to carry out the method according to claim 16.

29. A non-transitory computer program which, when executed by a processor, causes a vehicle control system including a control device to carry out the method according to claim 16.

30. A non-transitory computer-readable medium, comprising instructions that cause a vehicle control system including a control device to carry out the method according to claim 16.
